(19) United States
(12) Patent Application Publication
(10) Pub. No.: US 2007/0078659 A1
(43) Pub. Date: Apr. 5, 2007

(54) Wireless communication device for providing reliable voice-based web browsing

(76) Inventors: Ukrit Visitkitjakarn, Lakemoor, IL (US); John C. Johnson, Spring Grove, IL (US); Jianming J. Song, Barrington, IL (US)

Correspondence Address: MOTOROLA INC, 600 NORTH US HIGHWAY 45, ROOM AS437, LIBERTYVILLE, IL, 60048-5343, US

(21) Appl. No.: 11/241,170

(22) Filed: Sep. 30, 2005

(51) Int. Cl. G10L 21/00

(52) U.S. Cl. 704/275

(57) ABSTRACT

A wireless communication device for voice-based web browsing comprising a processor (204) coupled to a memory (206), a speech input device (224), and a display (216). The memory (206) stores voice commands and sequential values such that each voice command is associated with a sequential value. The speech input device (224) receives a voice input corresponding to a particular sequential value. The display (216) shows web pages one page at a time so that each web page has web links and sequential values assigned to web links. The processor (204) activates a web site associated with a web link corresponding to the particular sequential value in response to each occurrence of receiving the voice input.

### FIELD OF THE INVENTION

The present invention relates generally to the field of wireless communication device and, more particularly, to wireless communication device having web browsing capabilities.

### BACKGROUND OF THE INVENTION

Electronic communication devices, such as networked computers, may provide data communication capabilities such as web browsing. A web browsing application, operating on an existing electronic communication device, typically requires manual dexterity and coordination. In particular, a user needs to press buttons or areas of a touch screen to navigate through menus or otherwise control the browser. This manual access mode can be tedious and cause significant cognitive load to an average user.

Some electronic communication devices have web browsing capabilities that may be controlled by voice commands. A user may actuate so-called standard operations of the web browsing application by pronouncing a predetermined phrase corresponding to the name of the standard operation, such as back, forward, stop, refresh, home, search, bookmarks and history. Other operations are not associated with predetermined words, so the user may actuate the other operations pronouncing a phrase that may be associated with each operation or, more precisely, believed to be associated with each operation by the user. A speech recognition engine of an electronic communication device processes the pronounced phrase and a correlation engine of the device attempts to associate the processed information with a particular operation of the web browsing application. Recognition of a predetermined phrase is much easier since the recognition engine is prepared to recognize the phrase and the correlation engine is prepared to correlate the phrase to its corresponding operation. Accordingly, recognition of a predetermined phrase provides more accurate recognition, quicker operation and/or more optimized memory usage that recognition of other phrases.

Unfortunately, a significant portion of web browsing is directed to operations that do not correspond to the operation of these so-called standard operations. In particular, the operation of surfing from web link-to-web link is a major, if not primary, function of a web browsing application. Web links of interest vary from person-to-person and from day-to-day for each person. Also, new web links are created and older web links are inactivated or changed over time. Thus, it is impractical to assign predetermined phrases to existing web links. Thus, there is a need for an electronic communication device having voice browsing capabilities that provides the advantages of predetermined phrase recognition for surfing from web link to web link.

### BRIEF DESCRIPTION OF THE DRAWINGS

FIG. 1 is a planar view of exemplary screen shots that may be provided by an embodiment, more particularly a display of the preferred embodiment, in accordance with the present invention.

FIG. 2 is a block diagram of exemplary components of the embodiments described herein in accordance with the present invention.

FIG. 3 is a planar view of an exemplary screen shot that may be provided by another embodiment in accordance with the present invention.

FIG. 4 is a planar view of an exemplary screen shot that may be provided by yet another embodiment in accordance with the present invention.

FIG. 5 is a flow chart illustrating an operation of one or more embodiments in accordance with the present invention.

### DETAILED DESCRIPTION OF THE PREFERRED EMBODIMENTS

The present invention organizes information retrieval tasks in a standardized fashion and uses a relatively small set of pre-defined tags, words and/or phrases to navigate the information retrieval process. Due to the need for a relatively small set of pre-defined tags, embodiments in accordance with the present invention only require a simple recognition engine to achieve efficient and accurate results.

One aspect of the present invention is a wireless communication device for voice-based web browsing comprising a memory, a speech input device, a display and a processor. The memory stores a plurality of voice commands and a plurality of sequential values, in which each voice command is associated with a sequential value. The speech input device receives a voice input corresponding to a particular sequential value of the plurality of sequential values. The display shows a plurality of web links, in which the plurality of sequential values is assigned to the plurality of web links. The processor is coupled to the memory, the speech input device and the display, and activates a web site associated with a web link corresponding to the particular sequential value in response to each occurrence of receiving the voice input.

Another aspect of the present invention is a method of a wireless communication device for voice-based web browsing. A plurality of voice commands is defined with a plurality of sequential values. A web site is then activated, and the plurality of sequential values is assigned, in sequential order, to a plurality of web links in response to activating the first web site. Next, a particular voice command of the plurality of voice commands is received via the speech input device, in which the particular voice command corresponds to a particular sequential value of the plurality of sequential values. Thereafter, a second web site corresponding to a particular web link associated with a particular sequential value is activated in response to receiving the particular voice command.

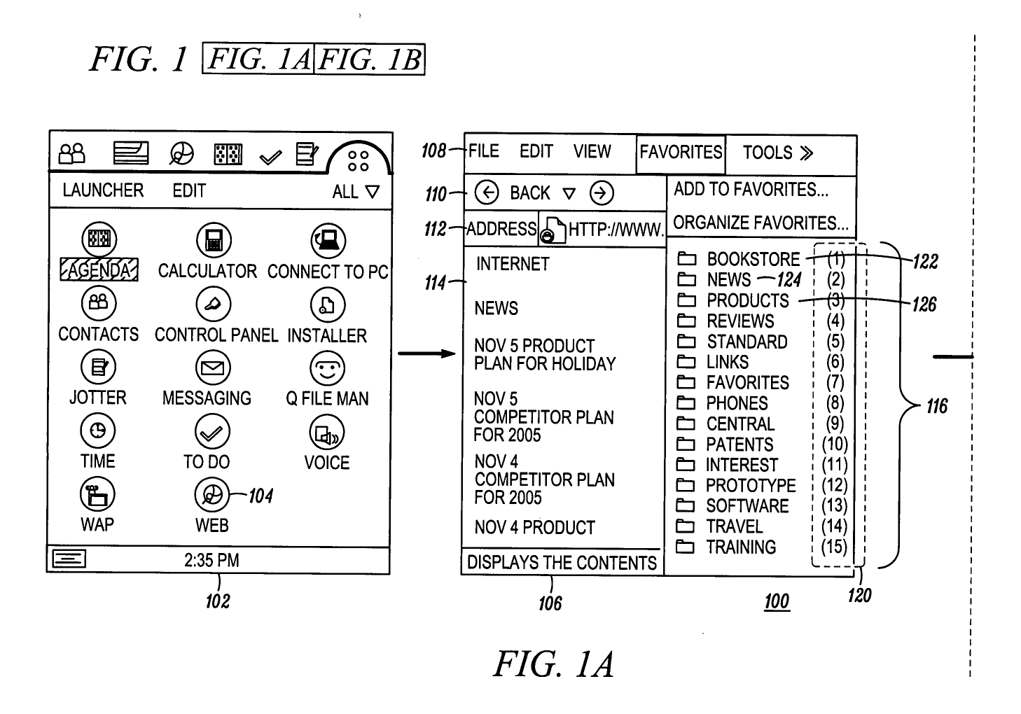

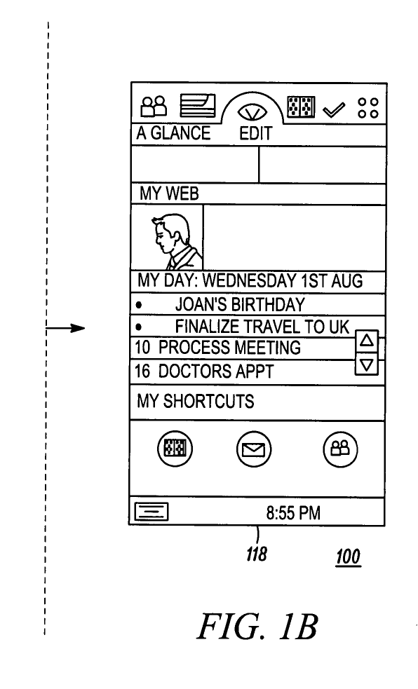

Referring to FIG. 1, there is shown a sequence 100 of three exemplary screen shots that may be provided at an output device, such as a display, of a wireless communication device in accordance with the present invention. The first screen shot 102 represents a general application of the wireless communication device providing a list of applications that may be initiated for operation by the device, one application being a voice-based web browsing application 104. A voice-based web browsing application 104 is an application that is capable of receiving commands or data input in the form of audio signals received from the user via the user interface of the wireless communication device. A user of the wireless communication may activate the web browsing application 104, thus providing a web browsing application at the output device, as represented by the second screen shot 106. The user may activate the web browsing application by any means enabled by the various components of the wireless communication device, such as a voice command, key selection, touch screen selection, and the like.

The second screen shot 106 provides information that may be use to the user of the wireless communication device, such as a menu list 108, a list of commands 110, a web address field 112 (such as an input area for a uniform resource locator), and content area of a web site 114. The web browsing application 104 also provides a list of web links or groups of web links for facilitated navigation to other web sites. For example, as shown in FIG. 1, the web browsing application 104 provides a list of folders 116 in which each folder represents a group of web links. By selecting a particular folder from this list of folders 116, the user will be provided a list of web links or a list of subfolders associated with this list of folders. In any case, the web browsing application may provide a list of web links, a list of groups of web links, or a combination of web links and groups of web links. If one or more groups of web links are provided, the web browsing application typically provides web links and/or groups of web links associated with each group of web links. Upon selection of a particular web link, the web browsing application provides the content of the selected web link, as represented by the third screen shot 118.

Referring back to the second screen shot 106, of particular interest are sequential values 120 provided with the list of web links, groups of web links, combination thereof. Each web link and group of web links is assigned with a sequential value, and an output device of the wireless communication clearly indicates the sequential value assigned to each web link or group of web links. Each sequential value may, for example, be positioned adjacent to its corresponding web link. For one embodiment, the sequential values assigned to the group of web links, i.e., folders, shown in the second screen shot 106 are numerical values. Sequential value “1” is assigned to the first folder 122, the sequential value “2” is assigned to the second folder 124, the sequential value “3” is assigned to the third folder 126, and so on. Sequential values may be assigned in any order, or randomly, to the web links and/or groups of web links on a web page, so long as sequential values are assigned to as many web links and/or groups of web links as possible. For example, as shown in the second screen shot 106, the sequential values are assigned from the top of the list down to the bottom of the list.

As shown by the second screen shot 106, the sequential values may be numerical values. However, it is to be understood that the sequential values may be any type of values that may have a commonly known sequential order associated with them. Examples of sequential values include, but are limited to, numerical values (binary, decimal, hexadecimal, and others), numerical representations (first, second third, etc.), alphabetical values (English, Greek, and other alphabets), code values (such as ASCII codes), and the like.

It is important to note that the same set of sequential values is re-used for each list of web links. For example, even though sequential values “1” through “15” have been assigned a first list of web links and/or groups of web links, sequential values “1” through “15” will be re-assigned to a second list of web links and/or groups of web links, regardless of whether the links or groups of links are similar or different. Thus, the sequential values are assigned to the web links, starting with the same initial value for each list of web links.

In addition, the values of the sequential values utilized for each web site may differ. For example, sequential values “1” through “99” may be available for use by any web site but, if a web site has less than 99 links or groups of links associated with it, then not all of the sequential values will be assigned for that web site. For another example, a web site may be associated with numerous links but only a partial number of links may be provided to the user at any given time. For example, the user may need to page through the web site page-by-page in order to view the entire web site. For one embodiment, sequential values may be assigned to all links and/or groups of links of the web site, and the user may see a partial list of sequential values as he or she pages through the web site. For another embodiment, sequential values may be assigned/re-assigned for each page of the web site, such that the same sequential values may be re-used for each page of the web site.

Apart from sequential values, a set of pre-defined voice commands may be used to navigate the web browsing. Examples of voice commands may include, but are not limited to, web browser, next page, previous page, forward, backward, add-to-favorites, history, exit, and the like.

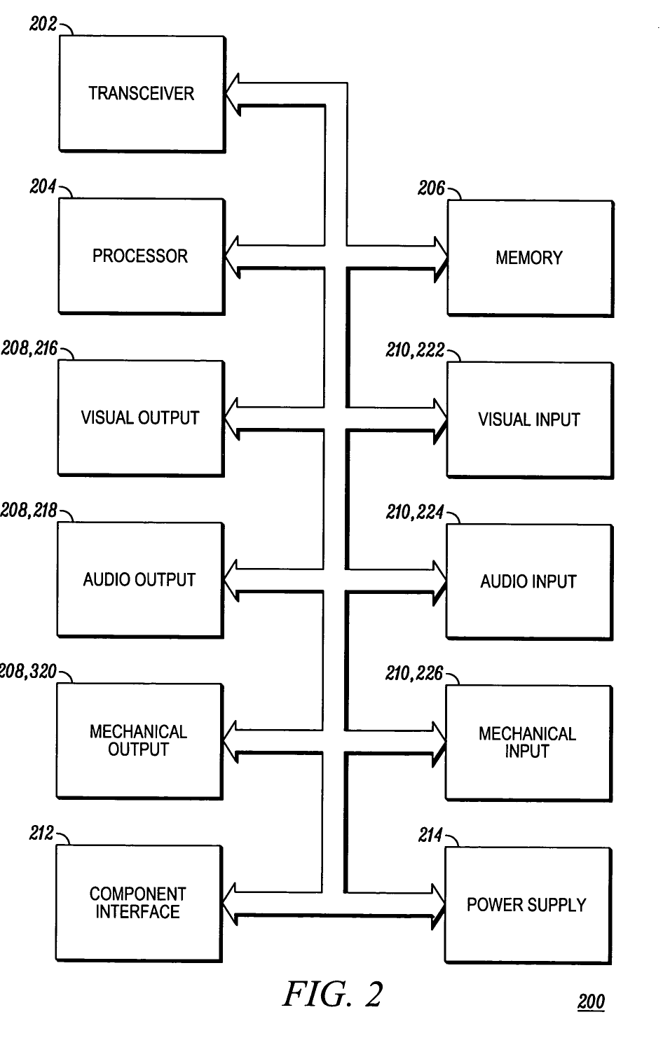

Referring to FIG. 2, there is provided a block diagram illustrating exemplary internal components 200 of a wireless communication device. The exemplary internal components 200 includes one or more wireless transceivers 202, one or more processors 204, one or more memory portions 206, one or more output devices 208, and one or more input devices 210. Each embodiment may include a user interface that comprises one or more output devices 208 and one or more input device 210. Each transceiver 202 may utilize wireless technology for communication, such as the wireless communication links or connections described above. The internal components 200 may further include a component interface 212 to provide a direct connection to auxiliary components or accessories for additional or enhanced functionality. The internal components 200 preferably include a power supply 214, such as a battery, for providing power to the other internal components while enabling the wireless communication device to be portable.

The wireless communication system may be any type of system that communicates with a plurality of wireless communication devices, communicating with one or more devices via a wireless link. Wireless links utilized by the wireless communication network include, but are not limited to, cellular-based communications such as analog communications (using AMPS), digital communications (using CDMA, TDMA, GSM, iDEN, GPRS, or EDGE), and next generation communications (using UMTS, WCDMA or CDMA2000) and their variants; a peer-to-peer or ad hoc communication technology such as HomeRF, Bluetooth, IEEE 802.11 (a, b or g), and IEEE 802.16; and other forms of wireless communication such as infrared technology. Also, the devices of the wireless communication system may also communicate with each other via a peer-to-peer or ad hoc communication technology, such as those technologies identified above.

An exemplary function of the wireless communication device 102 as represented by the internal components 200, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for one or more output devices 208. Likewise, for transmission of wireless signals, the processor 204 formats outgoing information, which may or may not be activated by the input devices 210, and conveys the outgoing information to the transceiver 202 for modulation to communication signals. The transceiver 202 conveys the modulated signals to a remote device. It is to be noted that the transceiver or transceivers 202 may utilize any type of wireless communication technology as described above.

The input and output devices 208, 210 of the internal components 200 may include a variety of visual, audio and/or mechanical outputs. For example, the output device(s) 208 may include a visual output device 216 such as a liquid crystal display and light emitting diode indicator, an audio output device 218 such as a speaker, alarm and/or buzzer, and/or a mechanical output device 220 such as a vibrating mechanism. Likewise, by example, the input devices 210 may include a visual input device 222 such as an optical sensor (for example, a camera), an audio input device 224 such as a microphone, and a mechanical input device 226 such as a flip sensor, keyboard, keypad, selection button, touch pad, touch screen, capacitive sensor, motion sensor, and switch. Actions that may actuate one or more input devices 210 include, but not limited to, opening the wireless communication device, unlocking the device, moving the device to actuate a motion, moving the device to actuate a location positioning system, and operating the device. It is important to note that the present invention requires an audio input device 224 or, more particularly, a speech input device to receive voice inputs corresponding to sequential values. The present invention also requires some sort of output device 208, such as a display, to convey web pages having web links and sequential values assigned to the web links.

The processor 204 of the internal components 200 may be a single circuit or divided-up into multiple circuits capable of performing various functions of the wireless communication device. The processor 204 may also be separate from or integrated with other components of the internal components 200. In any case, the processor 204 must be able to provide speech recognition functionality for recognition of voice commands, received from the audio input device 224, associated with sequential values.

The memory portion 206 of the internal components 200 may be used by the processor 204 to store and retrieve data. The data that may be stored by the memory portion 206 include, but is not limited to, operating systems, applications, media content and other data. Examples of stored applications include a web browsing application, and a speech recognition application that operates in conjunction with the processor 204 to form a speech recognition engine. As described herein, the memory portion 206 stores voice commands and sequential values in which each voice command is associated with a sequential value. Since the memory portion 206, in accordance with the present invention, only needs to store a relatively small set of pre-defined tags, words and/or phrases a speech recognition engine, the storage requirements of the memory portion may be minimal, i.e., significantly less than storage requirements for other devices having voice recognition engines.

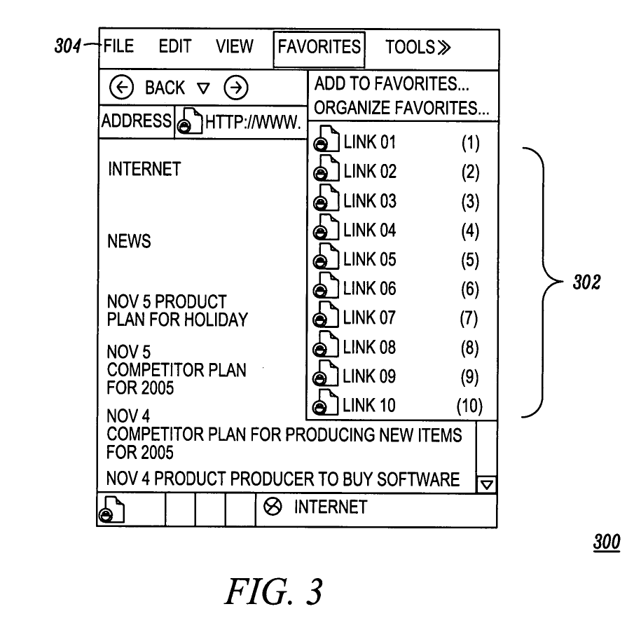

Referring to FIG. 3, there is provided an exemplary screen shot that may be provided by another embodiment in accordance with the present invention. As described above, the web browsing application 104 may provide a list of web links, groups of web links or a combination thereof. For example, the second screen shot 106 of FIG. 1 shows a list of groups of web links, i.e., folders. For the embodiment shown in FIG. 3, there is shown a list of web links 302 in which a sequential value is assigned to each web link.

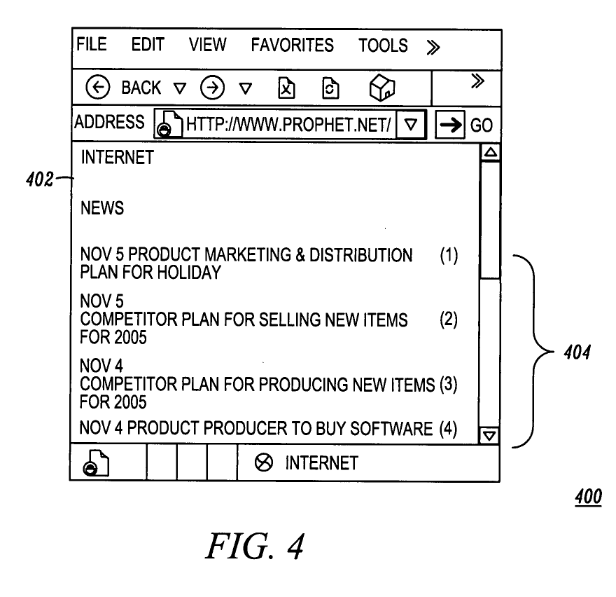

Referring to FIG. 4, there is provided an exemplary screen shot that may be provided by yet another embodiment in accordance with the present invention. As shown in FIGS. 1 and 3, the list of web links, groups of web links or combination of web links and groups of web links may provided upon activation of a menu item from the menu lists 108, 304. For the present invention, the list of web links, groups of web links or combination thereof may also extend from other parts of the web browsing application 104. For example, as shown in FIG. 4, web links may also be provided in the content area 114, 402 of the web browsing application 104. Accordingly, sequential values 404 may be assigned to each web link provided in the content area 402 of the web browsing application 104. It is important to note that the web links for this embodiment, as well as other embodiments in accordance with the present invention are not limited to text, but may also be images and objects, such as Java objects or animated objects.

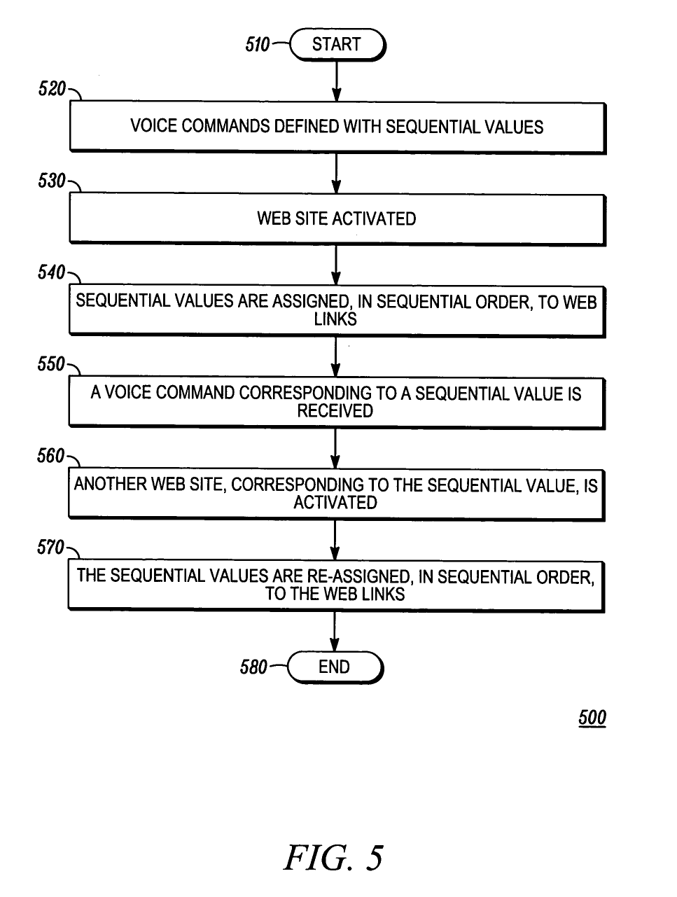

Referring to FIG. 5, there is provided a flow chart illustrating an operation 500 of one or more embodiments in accordance with the present invention. The operation 500 begins at step 510, and the voice commands are defined with sequential values at step 520. This step of defining the voice commands may occur at any time before an anticipated need for using the present invention but, preferably, should occur as early as possible since the need for voice-based web browsing may occur at any time. For example, the voice commands may be defined with sequential values before the user receives possession of the wireless communication device or soon after the user receives possession of the communication device.

At some point, after receiving possession of the wireless communication device, the user may initiate operation of the web browsing application and activate a web site, as represented by step 530. The web browsing application of the wireless communication device may then assign sequential values, in sequential order, to web links at step 540. Next, an audio input device 224 of the wireless communication device receives a voice command corresponding to a particular sequential value at step 550. A speech recognition engine, based on the processor 204 and corresponding application stored in the memory portion 206, will be able to identify the sequential value corresponding to the voice command efficiently and accurately due to the relatively small group of sequential values utilized.

As a result, the web browsing application activates another web site corresponding to the particular sequential value at step 560. Thereafter, if a new or different list of web links and/or groups of web links is identified, then the web browsing application re-assigns the same set of sequential values, in sequential order, to the new or different list of web links at step 570, and the operation 500 terminates at step 580.

The present invention allows a user to use a voice interface with an application, particularly a web browsing application, with high recognition accuracy and minimal memory requirements relative to other existing arts in the field. Predetermined sequential words may be tagged to the web links (not limited to text, thus may be images, java objects, and the like), folders, and sub-folders. This allows the user to navigate and/or control the application efficiently by pronouncing one of the predetermined sequential words which, in turn, reduces user cognitive load, improves user friendliness, and also strengthens the recognition accuracy. For example, leeway is provided to the user from foreign language terms or hard to pronounced words.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless communication device for voice-based web browsing comprising:
a memory configured to store a plurality of voice commands and a plurality of sequential values, each voice command being associated with a sequential value;
a speech input device configured to receive a voice input corresponding to a particular sequential value of the plurality of sequential values;
a display configured to show a plurality of web links, wherein the plurality of sequential values is assigned to the plurality of web links; and
a processor, coupled to the memory, the speech input device and the display, configured to activate a web site associated with a web link corresponding to the particular sequential value in response to each occurrence of receiving the voice input.

2. The wireless communication device of claim 1, wherein the plurality of sequential values are whole numbers.

3. The wireless communication device of claim 1, wherein the plurality of voice commands is based on user pronunciations of the plurality of sequential values.

4. The wireless communication device of claim 1, wherein each sequential value is provided, by the display, adjacent to its corresponding web link.

5. The wireless communication device of claim 1, wherein the plurality of sequential values is assigned to the plurality of web links, starting with the same initial value for each web site.

6. A method of a wireless communication device for voice-based web browsing, the wireless communication device include a display and a speech input device, the method comprising:
defining a plurality of voice commands with a plurality of sequential values;
activating a first web site;
assigning the plurality of sequential values, in sequential order, to a plurality of web links in response to activating the first web site;
receiving a particular voice command of the plurality of voice commands via the speech input device, the particular voice command corresponding to a particular sequential value of the plurality of sequential values; and
activating a second web site corresponding to a particular web link associated with a particular sequential value in response to receiving the particular voice command.

7. The method of claim 6, wherein defining a plurality of voice commands with a plurality of sequential values includes defining a plurality of whole numbers.

8. The method of claim 6, wherein defining a plurality of voice commands with a plurality of sequential values includes defining the plurality of voice commands based on user pronunciations of the plurality of sequential values.

9. The method of claim 6, wherein the plurality of voice commands is defined with the plurality of sequential values before activating the first web site.

10. The method of claim 6, further comprising re-assigning the plurality of sequential values, in sequential order, to the plurality of web links associated with the second web site in response to activating the second web site.
